(19) United States
(12) Patent Application Publication
(10) Pub. No.: US 2023/0388673 A1
(43) Pub. Date: Nov. 30, 2023

(54) PATCH-BASED IMAGE SENSOR

(71) Applicant: QUALCOMM Incorporated, San Diego, CA (US)

(72) Inventor: Edwin Chongwoo PARK, San Diego, CA (US)

(21) Appl. No.: 17/804,014

(22) Filed: May 25, 2022

(51) Int. Cl. H04N 5/369; H04N 5/378; H04N 5/351

(52) U.S. Cl. CPC H04N 5/3696; H04N 5/378; H04N 5/351

(57) ABSTRACT

In some aspects, an image sensor may include a plurality of pixels. The plurality of pixels may be grouped into a plurality of patches configured to provide input to a transformer model. The image sensor may include a read-out component configured to read out data from the plurality of pixels on a patch-by-patch basis. Numerous other aspects are described.

### FIELD OF THE DISCLOSURE

Aspects of the present disclosure generally relate to sensors and, for example, to a patch-based image sensor.

### BACKGROUND

Sensors are used within devices for various purposes. For example, a sensor may be used to sense one or more characteristics associated with an environment of a device. Image sensors are sensors that are used in devices, such as cameras or smartphones, to convert optical signals into electrical signals. An image sensor may include an array of sensor elements (e.g., photodetectors) and associated circuitry for reading data from the array of sensor elements and generating a digital image based on the data.

### SUMMARY

In some implementations, an image processing system includes an image sensor, including: a plurality of pixels, where the plurality of pixels are grouped into a plurality of patches configured to provide input to a transformer model; and a read-out component configured to read out data from the plurality of pixels on a patch-by-patch basis. The image processing system may include one or more processors configured to provide data for the plurality of patches as an input to the transformer model.

In some implementations, an image sensor includes a plurality of pixels, where the plurality of pixels are grouped into a plurality of patches configured to provide input to a transformer model; and a read-out component configured to read out data from the plurality of pixels on a patch-by-patch basis.

In some implementations, an apparatus includes an image sensor, including: a plurality of pixels, where the plurality of pixels are grouped into a plurality of patches configured to provide input to a transformer model; and a read-out component configured to read out data from the plurality of pixels on a patch-by-patch basis. The apparatus may include a memory, and one or more processors, coupled to the memory, configured to: obtain data read out from the plurality of pixels on the patch-by-patch basis; and provide data for the plurality of patches as an input to the transformer model.

In some implementations, a method includes reading out data from a plurality of pixels of an image sensor on a patch-by-patch basis, where the plurality of pixels are grouped into a plurality of patches configured to provide input to a transformer model; and providing data for the plurality of patches, on a patch-by-patch basis, as an input to the transformer model.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented, in accordance with the present disclosure.

FIG. 2 is a diagram illustrating example components of a device, in accordance with the present disclosure.

FIG. 3 is a diagram illustrating an example image processing system, in accordance with the present disclosure.

FIG. 4 is a flowchart of an example process associated with a patch-based image sensor, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

For multimodal sensing, machine learning can be used to process data for different sensor domains, such as an image domain, an audio domain, or the like. Different sensors used in multimodal sensing may have different interfaces and data types, as well as different sampling rates, different bit widths, different framing, different dynamic ranges, or the like. Due to this complexity, conventionally, each domain was processed separately and then combined. Moreover, while convolutional neural networks (CNNs) have been previously favored for image domain processing, the use of transformers has become more widespread.

In machine learning, a transformer is a type of machine learning model. A transformer is a deep learning model that uses “self-attention” by differentially weighting the significance of each part of data that is input to the transformer (e.g., a transformer is a neural network model that uses attention). Thus, a transformer does not need to process input data in order. Transformers may be used for natural language processing (NLP) and/or computer vision (CV).

In CV, a transformer may use a full attention mechanism or a partial attention mechanism (e.g., where a receptive field does not have to radiate outward). An image that is to be processed by a transformer may be segmented into multiple patches, and the transformer may process the multiple patches in any sequence. In some cases, the patches may be associated with positional encoding that identifies the positional relationship of the patches in the original image. Moreover, the transformer may learn to identify the positional relationship of the patches. Conventionally, the multiple patches are the same size and shape. A transformer may be a multimodal transformer that is capable of processing an input associated with multiple data types, such as an input that includes images (e.g., as patches), audio (e.g., as tokens), or the like.

Generally, an image sensor may be regularly sized and shaped. For example, the image sensor may be rectangular in aspect ratio, pixels of the image sensor may be arranged in equally-spaced rows and columns, the pixels may be the same size and aspect ratio, and the pixels may be read out by row or by column. Thus, addressing and reading out a rectangular image sensor may be straightforward. However, with regard to a lens (e.g., a circular lens) used with the image sensor or a focus of the image sensor, a rectangular image sensor may have disadvantages. For example, a focus and an energy of an image sensor may be highest at a center of the image sensor and may degrade moving away from the center. Accordingly, a rectangular image sensor may trade off areas associated with better qualities for areas associated with worse qualities (e.g., resulting in higher cost or complexity of the image sensor in order to compensate for these worse qualities). Furthermore, a non-rectangular image sensor may have increased silicon area for providing gates, logic, memory, or other processing, even if a rectangular die is used. Thus, for a rectangular image sensor, part of the sensor area may be dedicated for processing. In some cases, this part of the sensor area that is dedicated for processing may be a prime area of the image sensor.

A rectangular image sensor may be suitable for providing an input to a CNN, or a similar type of model, which, in contrast to a transformer model, may process the image by sweeping a kernel across the image. Moreover, memory management may be simplified for each layer of the CNN based on a rectangular image sensor. However, processing pipelines using a CNN, or a similar type of model, generally wait for all sensor data to be read out (or at least several complete rows of the sensor to be read out) before processing begins.

Some techniques and apparatuses described herein provide an image processing system that includes an image sensor having a plurality of pixels that are grouped into a plurality of patches. For example, a read-out component (e.g., read-out circuitry) of the image sensor may be configured to read out data from the plurality of pixels on a patch-by-patch basis. In this way, the image sensor may obtain image data in a manner that is already formatted for inputting to a transformer model. The image processing system (e.g., one or more processors of the image processing system) may be configured to provide the data for the plurality of patches, on a patch-by-patch basis, as an input to the transformer model.

Because the transformer model performs processing on a patch level, rather than on the image as a whole, patches of the image sensor may be configured differently from each other. In some aspects, the patches of the image sensor, and/or the pixels of the patches, may be non-uniformly shaped to improve the coverage and performance of the image sensor. In some aspects, patches may be read out from the image sensor at different rates to provide configurable exposure times for the patches based on locations of the patches on the image sensor. In some aspects, image capture settings (e.g., an automatic exposure control (AEC) setting, a gain setting, or the like) may be configured for the image sensor on a patch-by-patch basis, thereby improving the performance of the image sensor. In some aspects, data read out from one or more patches may be provided to the transformer model for processing before reading out all patches of the image sensor, thereby improving a speed and efficiency of the image capture and processing. Accordingly, configuration and operation of the image sensor at a patch level provides improved flexibility, efficiency, and performance.

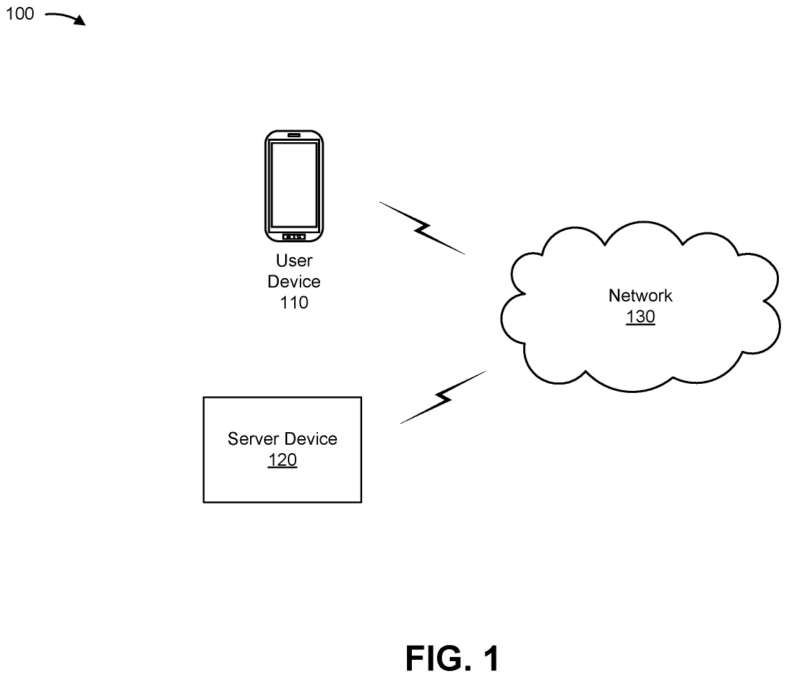

FIG. 1 is a diagram of an example environment 100 in which systems and/or methods described herein may be implemented, in accordance with the present disclosure. As shown in FIG. 1, environment 100 may include a user device 110, a server device 120, and a network 130. Devices of environment 100 may interconnect via wired connections, wireless connections, or a combination of wired and wireless connections.

The user device 110 includes one or more devices capable of receiving, generating, storing, processing, and/or providing information associated with image processing in connection with a patch-based image sensor, as described elsewhere herein. The user device 110 may include a communication device, a computing device, and/or an image capturing device. For example, the user device 110 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), a camera, an Internet of Things (IoT) device (e.g., a video doorbell or a surveillance camera), or a similar type of device. In some implementations, the user device 110 may implement a transformer model, such as for CV and/or NLP, among other examples.

The server device 120 includes one or more devices capable of receiving, generating, storing, processing, providing, and/or routing information associated with image processing in connection with a patch-based image sensor, as described elsewhere herein. The server device 120 may include a communication device and/or a computing device. For example, the server device 120 may include a server, such as an application server, a client server, a web server, a database server, a host server, a proxy server, a virtual server (e.g., executing on computing hardware), or a server in a cloud computing system. In some implementations, the server device 120 includes computing hardware used in a cloud computing environment. In some implementations, the server device 120 may implement a transformer model, such as for CV and/or NLP, among other examples.

The network 130 includes one or more wired and/or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 130 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

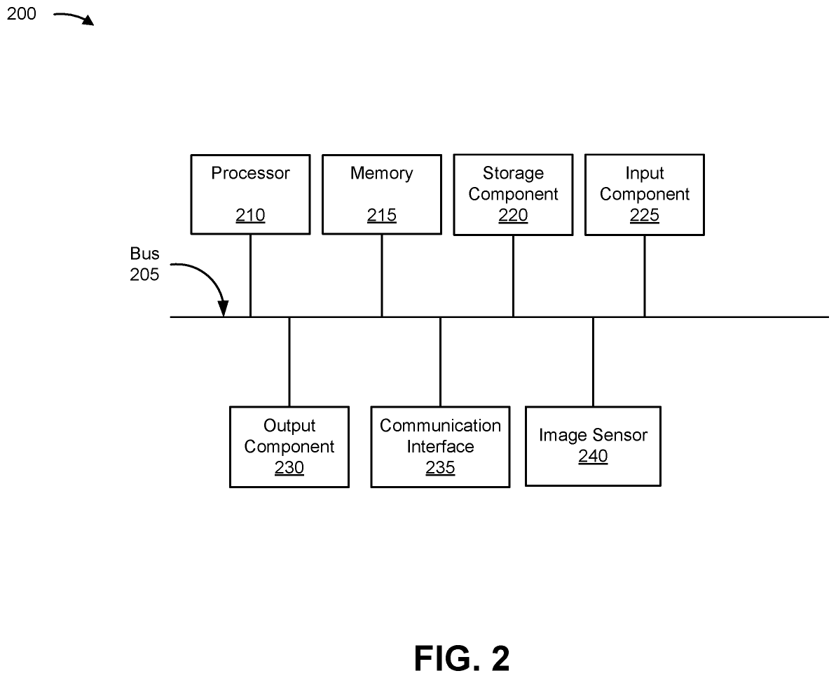

FIG. 2 is a diagram illustrating example components of a device 200, in accordance with the present disclosure. Device 200 may correspond to device 110 and/or server device 120. In some aspects, device 110 and/or server device 120 may include one or more devices 200 and/or one or more components of device 200. As shown in FIG. 2, device 200 may include a bus 205, a processor 210, a memory 215, a storage component 220, an input component 225, an output component 230, a communication interface 235, and/or an image sensor 240.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Image sensor 240 includes one or more devices to convert an optical signal into an electrical signal for use in generating a digital image. The image sensor 240 may include a complementary metal oxide semiconductor (CMOS) image sensor, a charge-coupled device (CCD) image sensor, or the like.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for reading out data from a plurality of pixels of an image sensor on a patch-by-patch basis, where the plurality of pixels are grouped into a plurality of patches configured to provide input to a transformer model, means for providing data for the plurality of patches, on a patch-by-patch basis, as an input to the transformer model, or the like. In some aspects, such means may include one or more components of device 200 described in connection with FIG. 2, such as bus 205, processor 210, memory 215, storage component 220, input component 225, output component 230, communication interface 235, and/or image sensor 240.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

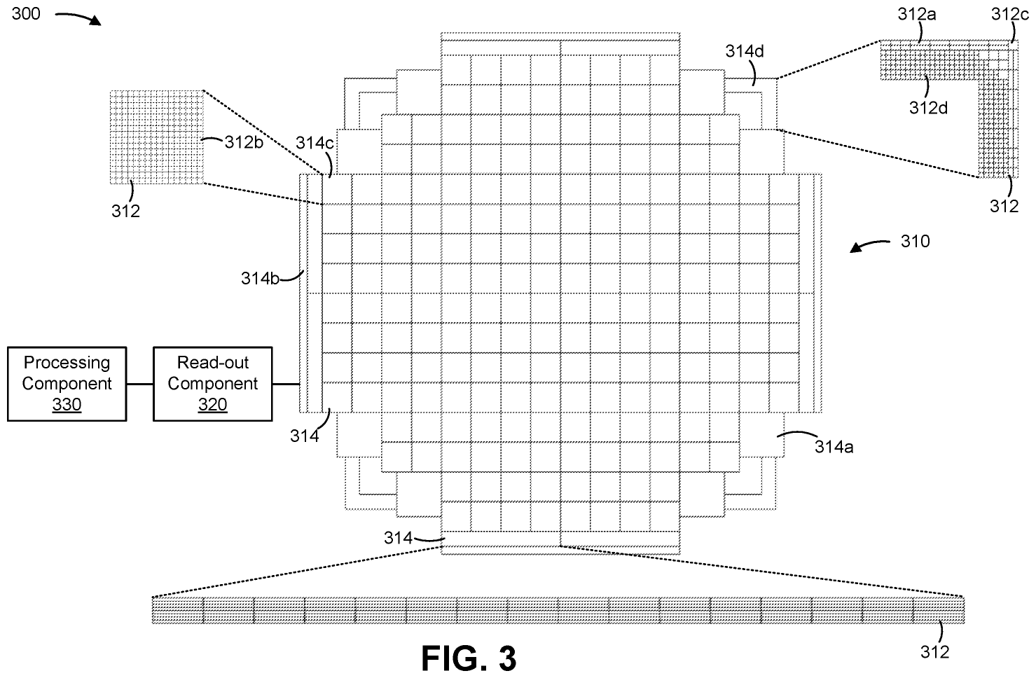

FIG. 3 is a diagram illustrating an example image processing system 300, in accordance with the present disclosure. As shown in FIG. 3, the image processing system 300 includes an image sensor 310, a read-out component 320, and/or a processing component 330. In some implementations, the image processing system 300 may include multiple read-out components 320 and/or multiple processing components 330 for the image sensor 310.

The image sensor 310 (e.g., a vision sensor) may include a plurality of pixels 312 (e.g., an array of pixels 312). A pixel 312 may include a photodetector (e.g., a photodiode) formed in a substrate (e.g., a silicon substrate) and associated circuitry for sampling data from the photodetector. The photodetector may be configured to convert photons of incident light into a photocurrent. In some aspects, one or more pixels 312 may overlap with each other. In some aspects, a first pixel 312 may be surrounded (e.g., fully surrounded or partially surrounded) by a second pixel 312 (e.g., concentric pixels 312).

The pixels 312 may be grouped into a plurality of patches 314. A “patch” may refer to a portion of a digital image that is for input to a transformer model. Thus, a patch 314 of the image sensor 310 may refer to a group of one or more pixels 312 that are to collect data relating to a portion of a digital image for inputting to a transformer model (e.g., where the combination of the plurality of patches 314 defines the full digital image). Accordingly, the sizes (e.g., photodetection area sizes), shapes (e.g., photodetection area shapes), and arrangement of the pixels 312 of a patch 314 may define a shape of the patch 314. A patch 314 may be an input to a transformer model, a patch 314 may be divided into multiple patches for inputting separately to a transformer model, and/or multiple patches 314 may be grouped for inputting together to a transformer model.

In some aspects, the patches 314 may be non-uniform (e.g., at least one patch 314 may be non-uniform with respect to at least one other patch 314). For example, multiple patches 314 may be differently shaped (e.g., at least one patch 314a may have a different shape from a shape of at least one other patch 314b). Additionally, or alternatively, multiple patches 314 (e.g., of the same shape) may be differently sized (e.g., at least one patch 314a may have a different size from a size of at least one other patch 314c). In some aspects, one or more patches 314 may be rectangular (e.g., in the shape of a square or a rectangle) and/or one or more patches 314 may be non-rectangular (e.g., L-shaped), such as patch 314d. In some aspects, patches 314 at a center of the image sensor 310 (e.g., patches 314 that are not at an edge of the image sensor 310) may be rectangular (e.g., square shaped) and uniformly sized and shaped. In some aspects, patches 314 at edges of the image sensor 310 may be non-uniformly sized and shaped (e.g., patches 314a, 314b, and 314d, at edges of the image sensor 310, are non-uniformly sized and shaped). In some aspects, one or more patches 314 at edges of the image sensor 310 may be larger (e.g., have a greater total photodetection area) than patches 314 at a center of the image sensor 310, thereby improving the performance of areas of the image sensor 310 that receive less light or that would otherwise perform poorly. For example, while patches 314 at a center of the image sensor 310 may be smaller squares, patches 314 at edges of the image sensor 310 may be larger squares, elongated rectangles, or L-shaped. These shapes are provided as examples, and one or more patches 314 may be shaped differently from the aforementioned shapes in some aspects.

In some aspects, multiple patches 314 may have different aspect ratios (e.g., at least one patch 314a may have a different aspect ratio from an aspect ratio of at least one other patch 314b). In some aspects, multiple patches 314 may include different quantities of pixels 312 (e.g., at least one patch 314c may include a different quantity of pixels 312 from a quantity of pixels 312 of at least one other patch 314d). Here, even patches 314 that are the same size and shape may include different quantities of pixels 312.

In some aspects, one or more pixels 312 may be rectangular (e.g., in the shape of a square or a rectangle) and/or one or more pixels 312 may be non-rectangular (e.g., L-shaped). In some aspects, pixels 312 at a center of the image sensor 310 (e.g., pixels 312 that are not at an edge of the image sensor 310) may be rectangular (e.g., square shaped) and uniformly sized and shaped, such as the pixels 312 of patch 314c. In some aspects, multiple pixels 312 at edges of the image sensor 310 may be non-uniformly sized and shaped, such as the pixels 312 of patch 314d. In some aspects, one or more pixels 312 at edges of the image sensor 310 may be larger (e.g., have a greater total photodetection area) than pixels 312 at a center of the image sensor 310 (e.g., pixel 312a may be larger than pixel 312b). For example, pixels 312 at a center of the image sensor 310 may be smaller squares (e.g., pixel 312b), while pixels 312 at edges of the image sensor 310 may be larger squares or elongated rectangles (e.g., pixel 312a). These shapes are provided as examples, and one or more pixels 312 may be shaped differently from the aforementioned shapes in some aspects.

In some aspects, pixels 312 in different patches 314 may be non-uniform (at least one pixel 312 may be non-uniform with respect to at least one other pixel 312). For example, pixels 312 in different patches 314 may be differently shaped, in a similar manner as described above. Additionally, or alternatively, pixels 312 in different patches 314 may be differently sized, in a similar manner as described above. In some aspects, at least one patch 314 (e.g., patch 314d) includes at least one pixel 312 (e.g., pixel 312c) that has a different photodetection area size from a photodetection area size of at least one other pixel 312 (e.g., pixel 312b) included in at least one other patch 314 (e.g., patch 314c). In some aspects, at least one patch 314 (e.g., patch 314d) includes at least one pixel 312 (e.g., pixel 312a) that has a different aspect ratio from an aspect ratio of at least one other pixel 312 (e.g., pixel 312b) included in at least one other patch 314 (e.g., patch 314c).

In some aspects, multiple pixels 312 in the same patch 314 may be non-uniform (e.g., pixel 312a and pixel 312c of patch 314d). For example, pixels 312 in the same patch 314 may be differently shaped, in a similar manner as described above. Additionally, or alternatively, pixels 312 in the same patch 314 may be differently sized, in a similar manner as described above. In some aspects, at least one patch 314 includes multiple pixels 312 having differently sized photodetection areas (e.g., at least one pixel 312c may have a differently sized photodetection area from a photodetection area of at least one other pixel 312d). In some aspects, at least one patch 314 includes multiple pixels 312 having photodetection areas that are different aspect ratios (e.g., at least one pixel 312a may have a different aspect ratio from an aspect ratio of at least one other pixel 312c). Alternatively, the pixels 312 in a patch 314 may have photodetection areas that are the same size (e.g., to provide the same light flux).

In some aspects, a combination of the patches 314 (e.g., as arranged on the image sensor 310) may define a shape that is rectangular. In some aspects, a combination of the patches 314 (e.g., as arranged on the image sensor 310) may define a shape that is non-rectangular. For example, as shown, the shape defined by the combination of the patches 314 may be approximately circular (e.g., a photodetection area of the image sensor 310 may be approximately circular). However, the shape defined by the combination of the patches 314 may be another shape, such as a shape that is approximately triangular, a shape that is approximately trapezoidal, or the like (e.g., in a use case where the image sensor 310 is to capture images in which the horizon is visible, but the sky does not include much information that is pertinent to the use case).

The read-out component 320 may include circuitry, or another mechanism, for reading out data from the pixels 312, and providing the data to the processing component 330 for processing. For example, the read-out component 320 may include a set of wires, electrical traces, and/or other types of current-carrying conductors that interconnect components of the read-out component 320, such as one or more switches (e.g., transistors), one or more amplifiers, one or more read-out registers, and/or one or more analog-to-digital converters. In some implementations, the read-out component 320 (e.g., the circuitry) may be configured to read out data from the pixels 312 on a patch-by-patch basis (e.g., rather than read out data by rows or by columns of pixels 312). That is, the read-out component 320 (e.g., the circuitry) may be configured to read out data from the image sensor 310 as a series of patches 314.

In some aspects, the read-out component 320 may be configured to read out data from at least one patch 314 at a different rate from a rate for reading out data from at least one other patch 314. In other words, the read-out component 320 may be configured to read out data from a first patch 314 at a first rate and to read out data from a second patch 314 at a second rate. In this way, patches 314 at edges of the image sensor 310 (e.g., which receive less light) may be read out at a slower rate than patches 314 at a center of the image sensor 310 to improve photodetection at the patches 314 at the edges. In some aspects, the patches 314 may be associated with respective configurations for data read out. For example, a first patch 314 may be associated with a first configuration for data read out, and a second patch 314 may be associated with a second configuration for data read out. A configuration for data read out may relate to a configuration (e.g., a physical configuration) of the read-out component 320 (e.g., of the circuitry) for reading out data from a patch 314 and may impact a read out rate of the patch 314, data binning for the patch 314, or the like.

The processing component 330 may include a memory and/or one or more processors. The image sensor 310 may include the processing component 330 or a portion thereof (e.g., on board the image sensor 310). Additionally, or alternatively, the processing component 330, or a portion thereof, may be a separate component that is in communication with the image sensor 310. In some aspects, the processing component 330 may control operation of the read-out component 320. The processing component 330 may be configured to perform local (e.g., individual) processing of data for the patches 314 (e.g., on a patch-by-patch basis).

In some aspects, the processing component 330 may configure (e.g., set or adjust) one or more settings for image capture by the image sensor 310 (e.g., settings that control the manner in which the image sensor 310 captures an image). The processing component 330 may configure the one or more settings on a patch-by-patch basis. That is, the processing component 330 may configure one or more settings for image capture for at least one patch 314 (e.g., a first patch 314) differently from a configuration of the one or more settings for image capture for at least one other patch 314 (e.g., a second patch 314). The settings for image capture may include an AEC setting, a gain setting (e.g., gain on readout or digital gain), and/or an exposure time setting, among other examples. In some aspects, each patch type (e.g., patch size, patch shape, or the like) and/or each pixel type (e.g., pixel size, pixel shape, or the like) may be associated with respective settings for image capture.

In some aspects, the processing component 330 may receive (e.g., from the read-out component 320) data for the patches 314 that is read out from the image sensor 310. In some aspects, the processing component 330 may perform pre-processing (e.g., noise reduction, brightness adjustment, contrast adjustment, resizing, or the like) of the patches 314 (e.g., sequentially) as the data for the patches 314 is obtained (e.g., on a patch-by-patch basis). In this way, the processing component 330 does not need to wait for the entire image sensor 310 (e.g., all patches 314) to be read out before beginning to perform pre-processing.

The processing component 330 may provide the data for the patches 314 (e.g., after any pre-processing) as an input to a transformer model. The processing component 330 may implement the transformer model, or another device (e.g., the server device 120) may implement the transformer model. The transformer model may be for CV or multimodal use. For example, the transformer model may be trained to identify a content of an image based at least in part on the data for the patches 314 that is input to the transformer model.

In some aspects, the processing component 330, to provide the data for the patches 314, may provide data for a first patch 314 as the input to the transformer model before providing data for a second patch 314 as the input to the transformer model. In other words, data for the patches 314 may be provided to, and processed by, the transformer model (e.g., sequentially) when the data for the patches 314 is obtained (e.g., on a patch-by-patch basis). In this way, the transformer model does not need to wait for the entire image sensor 310 (e.g., all patches 314) to be read out before beginning to process the data.

In some aspects (e.g., where the processing component 330 implements the transformer model), the processing component 330 may process, using the transformer model, the data for the patches 314 that is provided as the input. As described herein, processing using the transformer model may be performed without regard to any particular sequence of the patches 314 (e.g., a sequence in which the patches 314 are arranged on the image sensor 310), and the processing may be performed before all patches 314 have been read out from the image sensor 310 (e.g., the processing may begin once a single patch 314 has been read out from the image sensor 310). As described herein, the patches 314 may be non-uniform and may include non-rectangular patches 314. Thus, the transformer model may process patches 314 that are non-uniform and/or that include non-rectangular patches 314. An output of the transformer model may include information that identifies a content of an image captured by the image sensor 310 (e.g., a classification of an image captured by the image sensor 310). In some aspects, the processing component 330 may obtain the output of the transformer model (e.g., directly or from the other device implementing the transformer model). Moreover, the processing component 330 may perform, or may cause performance of, one or more operations based on the output of the transformer model.

In some aspects, the processing component 330, or another component, may collect statistics relating to the image sensor 310 on a patch-by-patch basis. For example, the statistics that are collected may relate to a value (e.g., an average value, a total value, a square value, an energy value, or the like) per patch 314 or may relate to values from a previous frame of data. For example, the statistics may relate to an energy associated with a patch 314, a sum of all the pixels 312 of a patch 314, a sum of the squares of all the pixels 312 of a patch 314, or the like.

In some aspects, the image processing system 300 may include multiple (e.g., a group of) image sensors 310 (e.g., a multivision sensor). Here, the read-out component 320 and/or the processing component 330 may be shared for the multiple image sensors 310, or the image processing system 300 may include respective read-out components 320 and/or processing components 330 for the multiple image sensors 310. The multiple image sensors 310 may be different sizes (e.g., aspect ratios) from each other (e.g., a first image sensor 310 may be a first size and a second image sensor 310 may be a second size). Moreover, different sampling rates may be used for the multiple image sensors 310 (e.g., a first sampling rate may be used for a first image sensor 310 and a second sampling rate may be used for a second image sensor 310).

In some aspects, the image processing system 300 may include multiple sensors that include the image sensor 310 and a sensor for at least one other modality (e.g., sound). Here, data from the multiple sensors may be read via the same interface. Moreover, circuitry, such as an analog-to-digital converter, for the multiple sensors may be included on the same die. In some aspects (e.g., when the image processing system 300 includes sensors for multiple modalities), the transformer model may be configured to receive multimodal inputs and to perform multimodal processing. In some aspects, each of the multiple sensors may be associated with different patch sizes (e.g., patch sizes, token sizes, or the like), and the transformer model may be configured to receive and process inputs of different patch sizes.

The image sensor 310 described herein may provide improved utilization of optimal silicon areas of the image sensor 310, such as by the non-uniformity of the patches 314 and/or the pixels 312. Thus, the image sensor 310 may be capable of collecting data having improved quality. Moreover, because data may be read out from the image sensor 310 in patches 314 that are already formatted for subsequent processing (e.g., by the transformer model), the image processing system 300 may conserve memory resources, processing resources, and/or power resources that would otherwise be used to format the data read out from the image sensor 310 for subsequent processing. In addition, the image sensor 310 may reduce or eliminate the use of pixels 312 that have a primary purpose of preserving a rectangular sensor shape rather than data collection, thereby conserving computing resources associated with such pixels 312. Relatedly, because the image sensor 310 has a relatively greater pertinent area used for data collection, the image processing system 300 may use fewer processing resources, may use less power, and may perform processing at faster speeds.

The image processing system 300 may be better equipped to handle large dynamic range differences between pixels 312 and/or between multimodal sensors because the patches 314 are independently read out from the image sensor 310. Moreover, pixels 312 may be assigned to patches 314 in a manner that optimizes performance, thereby facilitating low-power operation of the image processing system 300 and providing overall simplification of the image processing system 300.

Additionally, data collection from the image sensor 310 based on the patches 314 facilitates improved training of the transformer model because input data and types to the transformer model are aligned with the data collected by the image sensor 310. Data collection from the image sensor 310 based on the patches 314 also facilitates the use of multiple sensors and/or sensor modalities in the image processing system 300. Furthermore, data collection from the image sensor 310 on a patch-by-patch basis at different rates may result in shorter detection times and higher detection rates, thereby conserving memory resources, processing resources, and/or power resources.

As indicated above, FIG. 3 is provided as an example. Other examples may differ from what is described with respect to FIG. 3.

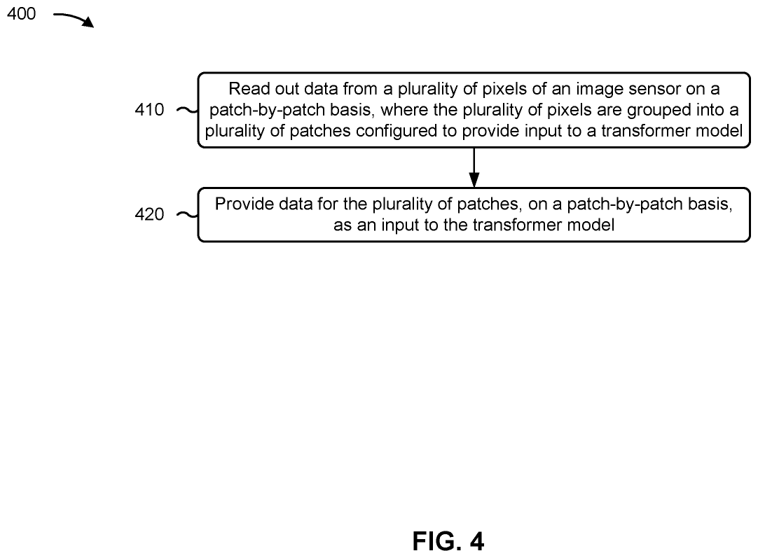

FIG. 4 is a flowchart of an example process 400 associated with a patch-based image sensor. In some implementations, one or more process blocks of FIG. 4 are performed by a user device (e.g., user device 110). In some implementations, one or more process blocks of FIG. 4 are performed by another device or a group of devices separate from or including the user device, such as a server device (e.g., server device 120). Additionally, or alternatively, one or more process blocks of FIG. 4 may be performed by one or more components of device 200, such as processor 210, memory 215, storage component 220, input component 225, output component 230, communication interface 235 and/or image sensor 240.

As shown in FIG. 4, process 400 may include reading out data from a plurality of pixels of an image sensor on a patch-by-patch basis, where the plurality of pixels are grouped into a plurality of patches configured to provide input to a transformer model (block 410). For example, the user device may read out data from a plurality of pixels of an image sensor on a patch-by-patch basis, as described above. In some implementations, the plurality of pixels are grouped into a plurality of patches configured to provide input to a transformer model.

As further shown in FIG. 4, process 400 may include providing data for the plurality of patches, on a patch-by-patch basis, as an input to the transformer model (block 420). For example, the user device may provide data for the plurality of patches, on a patch-by-patch basis, as an input to the transformer model, as described above.

Process 400 may include additional implementations, such as any single implementation or any combination of implementations described below and/or in connection with one or more other processes described elsewhere herein.

In a first implementation, process 400 includes configuring one or more settings for image capture for at least one patch, of the plurality of patches, differently from a configuration of the one or more settings for image capture for at least one other patch of the plurality of patches, the one or more settings including one or more of an automatic exposure control setting, a gain setting, or an exposure time setting.

In a second implementation, alone or in combination with the first implementation, reading out data from the plurality of pixels includes reading out data from at least one patch, of the plurality of patches, at a different rate from a rate for reading out at least one other patch of the plurality of patches.

In a third implementation, alone or in combination with one or more of the first and second implementations, process 400 includes processing the data for the plurality of patches using the transformer model.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: An image processing system, comprising: an image sensor, comprising: a plurality of pixels, wherein the plurality of pixels are grouped into a plurality of patches configured to provide input to a transformer model; and a read-out component configured to read out data from the plurality of pixels on a patch-by-patch basis; and one or more processors configured to: provide data for the plurality of patches as an input to the transformer model.

Aspect 2: The image processing system of Aspect 1, wherein at least one patch, of the plurality of patches, is non-uniform with respect to at least one other patch of the plurality of patches.

Aspect 3: The image processing system of any of Aspects 1-2, wherein one or more patches, of the plurality of patches, are non-rectangular.

Aspect 4: The image processing system of any of Aspects 1-3, wherein at least one patch, of the plurality of patches, includes a different quantity of pixels from a quantity of pixels included in at least one other patch of the plurality of patches.

Aspect 5: The image processing system of any of Aspects 1-4, wherein at least one patch, of the plurality of patches, includes at least one pixel, of the plurality of pixels, that has a different photodetection area size from a photodetection area size of at least one other pixel, of the plurality of pixels, included in at least one other patch of the plurality of patches.

Aspect 6: The image processing system of any of Aspects 1-5, wherein at least one patch, of the plurality of patches, includes at least one pixel, of the plurality of pixels, that has a different aspect ratio from an aspect ratio of at least one other pixel, of the plurality of pixels, included in at least one other patch of the plurality of patches.

Aspect 7: The image processing system of any of Aspects 1-6, wherein a patch, of the plurality of patches, includes at least one pixel, of the plurality of pixels, that has a differently sized photodetection area from a photodetection area of at least one other pixel, of the plurality of pixels, of the patch.

Aspect 8: The image processing system of any of Aspects 1-7, wherein one or more pixels, of the plurality of pixels, have photodetection areas that are non-rectangular.

Aspect 9: The image processing system of any of Aspects 1-8, wherein a combination of the plurality of patches defines a shape that is non-rectangular.

Aspect 10: The image processing system of any of Aspects 1-9, wherein the one or more processors, to provide data for the plurality of patches as the input to the transformer model, are configured to: provide data for a patch, of the plurality of patches, as the input to the transformer model before providing data for another patch, of the plurality of patches, as the input to the transformer model.

Aspect 11: The image processing system of any of Aspects 1-10, wherein the one or more processors are further configured to: configure one or more settings for image capture for at least one patch, of the plurality of patches, differently from a configuration of the one or more settings for image capture for at least one other patch of the plurality of patches, the one or more settings including one or more of: an automatic exposure control setting, a gain setting, or an exposure time setting.

Aspect 12: The image processing system of any of Aspects 1-11, wherein the read-out component is further configured to: read out data from at least one patch, of the plurality of patches, at a different rate from a rate for reading out at least one other patch of the plurality of patches.

Aspect 13: The image processing system of any of Aspects 1-12, wherein the plurality of patches are associated with respective configurations for data read out.

Aspect 14: The image processing system of any of Aspects 1-13, wherein one or more pixels, of the plurality of pixels, overlap.

Aspect 15: The image processing system of any of Aspects 1-14, wherein a first pixel, of the plurality of pixels, is surrounded by a second pixel of the plurality of pixels.

Aspect 16: An image sensor, comprising: a plurality of pixels, wherein the plurality of pixels are grouped into a plurality of patches configured to provide input to a transformer model; and a read-out component configured to read out data from the plurality of pixels on a patch-by-patch basis.

Aspect 17: The image sensor of Aspect 16, wherein at least one patch, of the plurality of patches, is non-uniform with respect to at least one other patch of the plurality of patches.

Aspect 18: The image sensor of any of Aspects 16-17, wherein at least one patch, of the plurality of patches, includes a different quantity of pixels from a quantity of pixels included in at least one other patch of the plurality of patches.

Aspect 19: The image sensor of any of Aspects 16-18, wherein at least one patch, of the plurality of patches, includes at least one pixel, of the plurality of pixels, that has a different photodetection area size from a photodetection area size of at least one other pixel, of the plurality of pixels, included in at least one other patch of the plurality of patches.

Aspect 20: The image sensor of any of Aspects 16-19, wherein a patch, of the plurality of patches, includes at least one pixel, of the plurality of pixels, that has a differently sized photodetection area from a photodetection area of at least one other pixel, of the plurality of pixels, of the patch.

Aspect 21: The image sensor of any of Aspects 16-20, wherein a combination of the plurality of patches defines a shape that is non-rectangular.

Aspect 22: An apparatus, comprising: an image sensor, comprising: a plurality of pixels, wherein the plurality of pixels are grouped into a plurality of patches configured to provide input to a transformer model; and a read-out component configured to read out data from the plurality of pixels on a patch-by-patch basis; a memory; and one or more processors, coupled to the memory, configured to: obtain data read out from the plurality of pixels on the patch-by-patch basis; and provide data for the plurality of patches as an input to the transformer model.

Aspect 23: The apparatus of Aspect 22, wherein at least one patch, of the plurality of patches, is non-uniform with respect to at least one other patch of the plurality of patches.

Aspect 24: The apparatus of any of Aspects 22-23, wherein at least one patch, of the plurality of patches, includes a different quantity of pixels from a quantity of pixels included in at least one other patch of the plurality of patches.

Aspect 25: The apparatus of any of Aspects 22-24, wherein at least one patch, of the plurality of patches, includes at least one pixel, of the plurality of pixels, that has a different photodetection area size from a photodetection area size of at least one other pixel, of the plurality of pixels, included in at least one other patch of the plurality of patches.

Aspect 26: The apparatus of any of Aspects 22-25, wherein a patch, of the plurality of patches, includes at least one pixel, of the plurality of pixels, that has a differently sized photodetection area from a photodetection area of at least one other pixel, of the plurality of pixels, of the patch.

Aspect 27: A method, comprising: reading out data from a plurality of pixels of an image sensor on a patch-by-patch basis, wherein the plurality of pixels are grouped into a plurality of patches configured to provide input to a transformer model; and providing data for the plurality of patches, on a patch-by-patch basis, as an input to the transformer model.

Aspect 28: The method of Aspect 27, further comprising: configuring one or more settings for image capture for at least one patch, of the plurality of patches, differently from a configuration of the one or more settings for image capture for at least one other patch of the plurality of patches, the one or more settings including one or more of: an automatic exposure control setting, a gain setting, or an exposure time setting.

Aspect 29: The method of any of Aspects 27-28, wherein reading out data from the plurality of pixels comprises: reading out data from at least one patch, of the plurality of patches, at a different rate from a rate for reading out at least one other patch of the plurality of patches.

Aspect 30: The method of any of Aspects 27-29, further comprising: processing the data for the plurality of patches using the transformer model.

Aspect 31: An apparatus for wireless communication at a device, comprising a processor; memory coupled with the processor; and instructions stored in the memory and executable by the processor to cause the apparatus to perform the method of one or more of Aspects 27-30.

Aspect 32: A device for wireless communication, comprising a memory and one or more processors coupled to the memory, the one or more processors configured to perform the method of one or more of Aspects 27-30.

Aspect 33: An apparatus for wireless communication, comprising at least one means for performing the method of one or more of Aspects 27-30.

Aspect 34: A non-transitory computer-readable medium storing code for wireless communication, the code comprising instructions executable by a processor to perform the method of one or more of Aspects 27-30.

Aspect 35: A non-transitory computer-readable medium storing a set of instructions for wireless communication, the set of instructions comprising one or more instructions that, when executed by one or more processors of a device, cause the device to perform the method of one or more of Aspects 27-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An image processing system, comprising:
an image sensor, comprising:
a plurality of pixels,
wherein the plurality of pixels are grouped into a plurality of patches configured to provide input to a transformer model; and
a read-out component configured to read out data from the plurality of pixels on a patch-by-patch basis; and
one or more processors configured to:
provide data for the plurality of patches as an input to the transformer model.

2. The image processing system of claim 1, wherein at least one patch, of the plurality of patches, is non-uniform with respect to at least one other patch of the plurality of patches.

3. The image processing system of claim 1, wherein one or more patches, of the plurality of patches, are non-rectangular.

4. The image processing system of claim 1, wherein at least one patch, of the plurality of patches, includes a different quantity of pixels from a quantity of pixels included in at least one other patch of the plurality of patches.

5. The image processing system of claim 1, wherein at least one patch, of the plurality of patches, includes at least one pixel, of the plurality of pixels, that has a different photodetection area size from a photodetection area size of at least one other pixel, of the plurality of pixels, included in at least one other patch of the plurality of patches.

6. The image processing system of claim 1, wherein at least one patch, of the plurality of patches, includes at least one pixel, of the plurality of pixels, that has a different aspect ratio from an aspect ratio of at least one other pixel, of the plurality of pixels, included in at least one other patch of the plurality of patches.

7. The image processing system of claim 1, wherein a patch, of the plurality of patches, includes at least one pixel, of the plurality of pixels, that has a differently sized photodetection area from a photodetection area of at least one other pixel, of the plurality of pixels, of the patch.

8. The image processing system of claim 1, wherein one or more pixels, of the plurality of pixels, have photodetection areas that are non-rectangular.

9. The image processing system of claim 1, wherein a combination of the plurality of patches defines a shape that is non-rectangular.

10. The image processing system of claim 1, wherein the one or more processors, to provide data for the plurality of patches as the input to the transformer model, are configured to:
provide data for a patch, of the plurality of patches, as the input to the transformer model before providing data for another patch, of the plurality of patches, as the input to the transformer model.

11. The image processing system of claim 1, wherein the one or more processors are further configured to:
configure one or more settings for image capture for at least one patch, of the plurality of patches, differently from a configuration of the one or more settings for image capture for at least one other patch of the plurality of patches, the one or more settings including one or more of:
an automatic exposure control setting,
a gain setting, or
an exposure time setting.

12. The image processing system of claim 1, wherein the read-out component is further configured to:
read out data from at least one patch, of the plurality of patches, at a different rate from a rate for reading out at least one other patch of the plurality of patches.

13. The image processing system of claim 1, wherein the plurality of patches are associated with respective configurations for data read out.

14. The image processing system of claim 1, wherein one or more pixels, of the plurality of pixels, overlap.

15. The image processing system of claim 1, wherein a first pixel, of the plurality of pixels, is surrounded by a second pixel of the plurality of pixels.

16. An image sensor, comprising:
a plurality of pixels,
wherein the plurality of pixels are grouped into a plurality of patches configured to provide input to a transformer model; and
a read-out component configured to read out data from the plurality of pixels on a patch-by-patch basis.

17. The image sensor of claim 16, wherein at least one patch, of the plurality of patches, is non-uniform with respect to at least one other patch of the plurality of patches.

18. The image sensor of claim 16, wherein at least one patch, of the plurality of patches, includes a different quantity of pixels from a quantity of pixels included in at least one other patch of the plurality of patches.

19. The image sensor of claim 16, wherein at least one patch, of the plurality of patches, includes at least one pixel, of the plurality of pixels, that has a different photodetection area size from a photodetection area size of at least one other pixel, of the plurality of pixels, included in at least one other patch of the plurality of patches.

20. The image sensor of claim 16, wherein a patch, of the plurality of patches, includes at least one pixel, of the plurality of pixels, that has a differently sized photodetection area from a photodetection area of at least one other pixel, of the plurality of pixels, of the patch.

21. The image sensor of claim 16, wherein a combination of the plurality of patches defines a shape that is non-rectangular.

22. An apparatus, comprising:
an image sensor, comprising:
a plurality of pixels,
wherein the plurality of pixels are grouped into a plurality of patches configured to provide input to a transformer model; and
a read-out component configured to read out data from the plurality of pixels on a patch-by-patch basis;
a memory; and
one or more processors, coupled to the memory, configured to:
obtain data read out from the plurality of pixels on the patch-by-patch basis; and
provide data for the plurality of patches as an input to the transformer model.

23. The apparatus of claim 22, wherein at least one patch, of the plurality of patches, is non-uniform with respect to at least one other patch of the plurality of patches.

24. The apparatus of claim 22, wherein at least one patch, of the plurality of patches, includes a different quantity of pixels from a quantity of pixels included in at least one other patch of the plurality of patches.

25. The apparatus of claim 22, wherein at least one patch, of the plurality of patches, includes at least one pixel, of the plurality of pixels, that has a different photodetection area size from a photodetection area size of at least one other pixel, of the plurality of pixels, included in at least one other patch of the plurality of patches.

26. The apparatus of claim 22, wherein a patch, of the plurality of patches, includes at least one pixel, of the plurality of pixels, that has a differently sized photodetection area from a photodetection area of at least one other pixel, of the plurality of pixels, of the patch.

27. A method, comprising:
reading out data from a plurality of pixels of an image sensor on a patch-by-patch basis,
wherein the plurality of pixels are grouped into a plurality of patches configured to provide input to a transformer model; and
providing data for the plurality of patches, on a patch-by-patch basis, as an input to the transformer model.

28. The method of claim 27, further comprising:
configuring one or more settings for image capture for at least one patch, of the plurality of patches, differently from a configuration of the one or more settings for image capture for at least one other patch of the plurality of patches, the one or more settings including one or more of:
an automatic exposure control setting,
a gain setting, or
an exposure time setting.

29. The method of claim 27, wherein reading out data from the plurality of pixels comprises:
reading out data from at least one patch, of the plurality of patches, at a different rate from a rate for reading out at least one other patch of the plurality of patches.

30. The method of claim 27, further comprising:
processing the data for the plurality of patches using the transformer model.
